(19) United States
(12) Patent Application Publication
(10) Pub. No.: US 2009/0011315 A1
(43) Pub. Date: Jan. 8, 2009

(54) Thin-Film Composite and a Glass Ceramic Substrate Used in a Miniaturized Electrochemical Device

(75) Inventors: Ludwig J. Gauckler, Zurich (CH); Daniel Beckel, Zurich (CH); Ulrich Muecke, Zurich (CH); Patrik Muller, Dorf (CH); Jennifer Rupp, Zurich (CH)

Correspondence Address: BACHMAN & LAPOINTE, P.C., 900 CHAPEL STREET, SUITE 1201, NEW HAVEN, CT, 06510, US

(73) Assignee: EIDGENOSSISCHE TECHNISCHE HOCHSCHULE ZURICH, Zurich (CH)

(21) Appl. No.: 12/090,864

(22) PCT Filed: Oct. 17, 2006
(86) PCT No.: PCT/CH2006/000575

§ 371 Date: Sep. 20, 2008

(30) Foreign Application Priority Data
Oct. 19, 2005 (CH) 1682/05

(51) Int. Cl. H01M 8/10; H01M 8/04; C03C 15/00

(52) U.S. Cl. 429/33; 429/12; 429/34; 216/95; 216/87

(57) ABSTRACT

A composite element comprising a thin film that consists of at least two layers of an oxide-ceramic and metallic material, or a metallic material and an essentially flat substrate that supports the thin film. Said substrate is composed of a ceramicizable glass, a glass ceramic, a hybrid form or an intermediate product. To produce the substrate, selected regions are dissolved out of the photostructurable glass substrate. The composite element can be successfully used in a miniaturised electrochemical device, in particular in a solid oxide fuel cell SOFC, a sensor or as a gas separation membrane.

### TECHNICAL FIELD

The invention relates to a composite element comprising at least one thin film that consists of at least two different layers of an oxide-ceramic material, an oxide-ceramic and metallic material or a metallic material and comprising an essentially flat substrate that supports the thin film. Furthermore, the invention relates to a method for structuring the substrate and to uses of the composite element with the thin film.

### PRIOR ART

Thin films, in particular electrically conducting thin films of ceramic and/or metallic materials are currently gaining in importance the whole time. The thin films generally consist of a number of layers, in particular three to five, the material and/or the morphology of the individual layers generally being different. The thin film is deposited in layers on the substrate, customary thin-film techniques being used, for example chemical vapor deposition, pulsed laser vapor deposition, sol-gel methods, in particular rotational coating, or spray pyrolysis. Furthermore, the thin film may be applied to the substrate as a whole or layer by layer as such. After or during the application, the layers or the thin film as a whole is or are annealed in a single-stage or multi-stage process, to obtain a partially or fully crystalline microstructure. Multilayer thin films are also referred to as laminates.

U.S. Pat. No. 6,896,989 B2 describes thin films that are applied to a substrate, consist of a number of layers and can be used as electrodes and solid electrolyte in fuel cells. Arranged between these functional layers are further layers, also made of the material of the electrode. Optionally, additional layers of different materials may also be added. According to this patent specification, the individual layers of the thin film are deposited by methods that are known per se, such as RF (radio frequency) sputtering, PVD (physical vapor deposition), CVD (chemical vapor deposition) and electrophoresis.

The known substrates are unable to satisfy requirements for thin films that have a number of layers and correspondingly complex properties of their mechanical structure (crack formation, inadequate service life).

### SUMMARY OF THE INVENTION

The present invention is based on the object of providing a composite element that is stable mechanically and under elevated temperatures comprising at least one thin film and a substrate of the type mentioned at the beginning, so that miniaturized electrochemical devices produced with the composite element have a high power density and good material compatibility. In particular, a substrate which mitigates mechanical stresses and is suitable for complex multilayer structures is to be proposed.

The object is achieved according to the invention with respect to the composite element by the substrate consisting of a ceramicizable glass, a glass ceramic, a mixed form or an intermediate state of the two.

The combination according to the invention of multilayer thin films and ceramicizable glass achieves the effect that the substrate softens to a certain extent at the temperatures of the production process and the stresses occurring in the multilayer thin film are reduced. Because, in the arrangement according to the invention, the substrate adapts itself to the thin film on account of the softening, the stress-induced deformations of the layers do not lead to cracks and ruptures.

Special embodiments and further developments of the invention are the subject of dependent patent claims.

Hereafter, the expression glass or glass substrate always includes a ceramicizable glass, a glass ceramic, a mixed form or an intermediate state of the two.

The substrate is preferably a light-sensitive, structurable glass which can be etched. The light-sensitive glass FOTURAN from the MIKROGLAS company is particularly suitable. This special glass is generally pore-free, but may also be formed such that it is completely porous or porous over certain zones. Further advantageous properties of this glass are the chemical, dimensional and thermal stability and the homogeneity.

The substrate that is used according to the invention has a coefficient of thermal expansion lying in the range of the ceramic layers of the thin film that is applied. This range lies in practice at (5-20)·10⁻⁶K⁻¹. A composite element with a coefficient of thermal expansion of the thin film in the range of (8-15)·10⁻⁶K⁻¹ and a coefficient of thermal expansion of the glass in the range of (8-10)·10⁻⁶K⁻¹ is expedient. Neighboring or overlapping coefficients of thermal expansion have obvious advantages, in particular with respect to the stability of the composite under shock-like temperature changes. With greatly differing coefficients of thermal expansion, these may lead to defects, deformations and destruction. Substrates based on silicon, for example, have a coefficient of thermal expansion that is three to five times lower than the ceramic materials of the thin film, for which reason these substrates cannot be used in the present case.

Sufficient mechanical stability is imparted to the thin film by the thickness of a glass substrate supporting it usually corresponding to at least approximately five times, preferably at least approximately ten times, the total layer thickness of the thin film. The glass substrate may be formed such that it is flexible, for example as a sheet, or rigid, for example as a plate. Both embodiments of the substrate can be impermeable, porous over the entire surface area or parts thereof and/or have holes or channels that can be configured as desired, which is referred to as a structured substrate. At least parts of the porous regions and the holes or channels are covered by the thin film, which in this function is referred to as a membrane. The channels also serve for fluid distribution; they may also be formed as grooves that pass only part of the way through the substrate. According to a special embodiment of the invention, the thin film may also be formed such that it is as thick as or thicker than the substrate. For the sake of simplicity, any ceramic layer composite is referred to in the present case as a thin film.

The holes or channels passing through the substrate are expediently each at least 100 μm² in size and of any desired, but expedient, geometrical form. The surface area of these holes or channels is set an upper limit by the mechanical stability of the thin film acting as a membrane and of the substrate itself.

As mentioned, a major advantage of thin films in the submicron range is that the grains exhibit only limited growth over time; they no longer grow once they reach a grain size dependent on the material and the production method. This relaxation time generally lies between 5 and 20 hours, in particular around 10 hours. An essentially stable grain size can be maintained at temperatures up to preferably approximately 1100° C.

An approximately stable grain size is understood in the present case as meaning that the remaining deviation after the relaxation time is at most approximately ±5%, preferably at most approximately ±2%. In the case of a grain size of, for example, 500 nm, the subsequent grain growth lies in the range of at most approximately 25 nm, in particular at most approximately 10 nm.

The individual layers of the thin film may be of any desired thickness; it expediently lies in a range of from 5 to 10,000 nm, preferably from 10 to 1000 nm, with an average grain size K of at most approximately 200 nm, preferably from 5 to 100 nm. With respect to the layer thickness of an individual layer of the thin film, the grain size K is preferably at most approximately 50%, in particular at most approximately 20%. Here and hereafter, an amorphous layer structure is not specifically mentioned but is analogously attributed to the fine-grained thin films.

The thin film preferably always has at least one layer that is ionically or ionically and electronically conducting, in particular for O₂ ions. This layer, the solid electrolyte, is always predominantly ionically conducting, and at most slightly electronically conducting.

The overall electrical conductivity is generally in the range from 0.02 to 10⁵ S/m (Siemens/meter). Electrical conductivity may be required on an application-related basis, for example in the case of electronically active electrodes and electrolytes that are used together or individually as miniaturized sensors, gas separating membranes or solid oxide fuel cells (SOFC).

The thin film may comprise various layers of a laminar structure that are in themselves homogeneous, with a chemical composition, morphology and/or porosity that is slightly changed continuously from layer to layer, a gradient being established with respect to the chemical composition, morphology and porosity. If, for example, one or more layers of the thin film is or are porous, the porosity is in a range from >0 to 70% by volume. The porosity may vary from layer to layer, with a continuous increase or decrease to form a porosity gradient.

The thin film that is used most frequently in practice comprises an anode layer, a solid electrolyte layer and a cathode layer, all the layers being electrically conducting. Depending on requirements, these layers may comprise further layers lying in between or formed as outer layers.

The layers of the thin film consist of at least one oxide ceramic and at least one metal, but also of a mixture of at least one oxide ceramic and at least one metal; the latter composition is also known as cermet. A thin film may not be purely metallic; at least one layer must be predominantly ionically conducting. The layers of the thin film may be amorphous, two-phase amorphous-crystalline or completely crystalline.

A fluid distributor for the fluid flowing through or flowing over is arranged in the free surface of the substrate, that is to say in the side of the surface that is facing away from the thin film, and is expediently formed in the shape of a channel or groove. The channel-shaped embodiment passes through the substrate completely; it is covered by the membrane stretched over. A groove-shaped fluid distributor, on the other hand, is merely cut out partially from the substrate in terms of depth.

It is particularly advantageous to provide between the layers forming the SOFC and the substrate a metal layer (as the lowermost layer of the thin film), which acts in the exposed parts of the membrane as a protective layer, etching resist, bonding layer, seal or diffusion barrier between the substrate and the layers that follow. On account of its metallic conductivity, the lowermost layer also serves for the electrical contacting of the layers lying above. Depending on the function, the metal layer may be structured during application or subsequently, or be impermeable or porous. Porosity or a holey structure are advantageous if gas access to the thin film lying above is to be ensured. The metal layer consists with preference of at least one of the substances Co, Fe, Cr, Ti, Cu, Au, Ag, Ni, Pt, Ta, Si, Pd, Ru or Rh. If required, an insulating layer consisting of SiCₓ, SiNₓ and SiOₓ may be applied. According to a further special embodiment of the invention, at least part of the composite region between the thin film and the glass substrate may comprise a heating element, which can additionally introduce heat, for example into a miniaturized SOFC.

A thin film applied to the substrate preferably has a grain size of at most approximately 500 nm in all the layers. In at least one of these layers, an essentially stable grain size is retained after a relaxation time, even in an elevated temperature range, which has positive effects on the properties.

The individual layers of the thin film covering the openings in the substrate do not have to be of the same size with respect to surface area. At least one layer of the thin film must cover at least one of the substrate openings. Each of the other layers of the thin film may cover this first layer entirely or partially or extend beyond the first layer. The layers of the thin film acting as a membrane may be structured by selective depositing or etching, by lift-off or masking techniques, or by any desired combination of these forms of deposition or in any desired form.

For miniaturized devices with electrochemically active electrodes and a solid electrolyte, a thin film with at least three of these fine-grained layers one on top of the other may be applied to a substrate as a membrane. As mentioned at the beginning, the working techniques are known per se.

One or more layers of the thin film may consist of a metal or a metal oxide, for example of Cu, Co, Mn, Ag or NiOₓ, FeOₓ, MnOₓ, CuOₓ, CoOₓ, and MnOₓ, AgOₓ, RuOₓ or mixtures of metals and or metal oxides. Furthermore, an oxide-ceramic component with ionic or mixed ionic and electronic conductivity, such as for example doped ceroxide AₓCe₁₋ₓO_{2-δ}, where A=Gd, Sm, Y, Ca, 0.05≦x≦0.3, or doped zirconium oxide Ln_{y}Zr_{1-y}O_{2-δ}, where Ln=Y, Sc, Yb, Er, 0.08≦y≦0.12, may be added to the metal, metal oxide or the mixture of metal and metal oxide. The proportion by volume of the metal and oxide-ceramic component lies between 20 and 80% by volume. The proportion by volume of the metallic phase of the solid part of the cermet lies between 0 and 70% by volume. The ratio between metal and oxide ceramic may be both uniformly distributed and singly or multiply graduated over the film thickness, with a ratio between 0 (no metal in the layer) and 100% (pure metal layer) of metal at each location of the thin film. The porosity of the thin film ranges from 0 to 50% in the oxidized state; all the metallic components are in the form of metal oxide, and >0 to 70% for the reduced state; all the metallic components are in the form of metal with a homogeneous or a non-homogeneous distribution in the thin film. The porosity may take the form of a gradient from impermeable to 70% porosity of the thin film. The average grain size K of the materials can be determined by thermal annealing at different temperatures; it comprises average grain sizes K of from 5 to 500 nm. The oxide-ceramic phase of the layers of the thin film have stable microstructures as a function of time under reducing conditions at temperatures of up to 700° C. If the metal content lies above a certain limit volume from which the metallic conduction becomes perceptible, the overall electrical conductivity between room temperature and 700° C. is greater than 10 S/m; the metal is in a reduced, that is to say metallic, state. All these materials can be coated, impregnated or doped with the following metals, or form composite materials with these metals, for example Ag, Au, Cu, Pd, Pt, Rh and Ru.

Furthermore, one or more of the layers of the thin film may consist of doped ceroxide AₓCe₁₋ₓO_{2-δ}, where A=Gd, Sm, Y, Ca, 0.05≦x≦0.3, or of doped zirconium oxide Ln_{y}Zr_{1-y}O_{2-δ}, where Ln=Y, Sc, Yb, Er, 0.08≦y≦0.12, or of LaₓSrₓGa_{1-y}Mg_{y}O_{3±δ}, with 0≦x≦1 and 0≦y≦1. The layers of this thin film are of an impermeable nanostructure and have a film thickness of between 10 and 5000 nm. A thin film with layers of an average grain size K of between 5 and 500 nm can be produced. This thin film has the following electrical properties:

a) An overall electrical conductivity of between 0.02 and 5 S/m at 500° C. and 0.25 and 10 S/m at 700° C., both measured in air.

b) An activation energy of the electrical conductivity in air of between 0.5 and 1.5 eV within the temperature range of 100 to 1000° C.

c) The electrolytic domain boundary is at 500° C. under oxygen partial pressures lower than 10⁻¹⁹ atm and at 700° C. under oxygen partial pressures lower than 10⁻¹⁴ atm.

Furthermore, one or more layers of the thin film may consist of a perovskite of the type AₓA′₁₋ₓB_{y}B′_{1-y}O_{3±δ}, where A, A′, B and B′ are any of the following elements: Al, Ba, Ca, Ce, Co, Cu, Dy, Fe, Gd, La, Mn, Nd, Pr, Sm, Sr, Y and 0≦x≦1, 0≦y≦1. According to a subvariant, pyrochlore ruthenates of the composition A₂Ru₂O_{7±δ}, where A=Bi, Y, Pb or A_{2-α}A′_{α}MO_{4±δ} with (A=Pr, Sm; A′=Sr; M=Mn, Ni; 0≦α≦1) or a material of the following composition: A₂NiO_{4±δ} (A=Nd, La); AₓB_{y}NiO_{4±δ} with A, B=Al, Ba, Ca, Ce, Co, Cu, Dy, Fe, Gd, La, Mn, Nd, Pr, Sm, Sr, Yₐ and 0≦x≦1, 0≦y≦1, or La₄Ni₃₋ₓCoₓO_{10±δ}, or YBa(Co,Fe)₄O_{7±δ} or Baln₁₋ₓCoₓO_{3±δ} or Bi₂₋ₓYₓO₃ (0≦x≦1) or La₂Ni₁₋ₓCuₓO_{4±δ} (0≦x≦1), or Y₁Ba₂Cu₃O₇ is used. All these materials can be coated, impregnated or doped with the following metals or form composite materials with these metals: Ag, Au, Cu, Pd, Pt, Rh and Ru. Furthermore, the thin films may comprise a mixture of these materials with doped ceroxide AₓCe₁₋ₓO_{2-δ}, where A=Gd, Sm, Y, Ca, 0.05≦x≦0.3, or doped zirconium oxide Ln_{y}Zr_{1-y}O_{2-δ}, where Ln=Y, Sc, Yb, Er, 0.08≦y≦0.12, or La₁₋ₓSrₓGa_{1-y}Mg_{y}O_{3±δ}, where 0≦x≦1 and 0≦y≦1. The thin films preferably have a layer thickness of between 50 and 10,000 nm and an average grain size K of between 5 and 500 nm. The overall electrical conductivity at 550° C. is in the range between 10 and 100,000 S/m in air. The thin films are stable in air and may be impermeable or porous with a porosity of between >0 and 70% by volume.

Finally, in addition to at least one ceramic or cermet layer, one or more layers of the thin film may be in the form of a metal or a metal mixture, for example Pt, Au, Ag, Ni and others, which are produced by sputtering techniques, such as RF (radio frequency) or direct-current sputtering, a vapor depositing technique or any other vacuum technique, electrochemical deposition or a paste of metal oxide powder and any organic or non-organic component.

With respect to the method, the object is achieved according to the invention by regions being selectively dissolved out of the structurable glass substrate.

Preferably, the parts of the surface that are to be removed are exposed to UV, heated up for at least partial, selective transformation into glass ceramic, and the exposed parts are specifically removed. The parts that are not exposed may be subsequently ceramicized.

The method is carried out by means of process techniques that are known per se. The untreated glass substrate is covered with a mask or a photoresist in such a way that only the parts of the substrate that are to be removed are left free, while the other parts are covered. Exposure to UV rays and subsequent heat treatment in an oven are performed in accordance with specifications of the glass manufacturer. The exposed parts of the glass substrate are thereby crystallized at least partially. After the removal of the substrate from the oven, the at least partially crystallized glass ceramic is dissolved out, for example by etching, likewise in accordance with the specifications of the glass manufacturer. This produces exactly delimited holes or channels, which reach as far as the protective layer mentioned or as far as the thin film, which are not attacked, or only a little, by the etchant. Finally, the remaining substrate can be completely or further ceramicized in an oven. As mentioned, we are concerned here with miniaturized substrates; the holes are at least 100 μm² in size, that is to say in the case of square openings have a side length of at least 10 μm. The surface area of a clearance generally remains well below one mm².

The main use of a composite element according to the invention comprises use in a miniaturized electrochemical device, in particular in a solid oxide fuel cell, a sensor or as a gas separating membrane.

### BRIEF DESCRIPTION OF THE DRAWINGS

The invention is explained in more detail on the basis of exemplary embodiments that are represented in the drawing and are the subject of dependent patent claims. In the schematic cross sections:

FIG. 1 shows a thin film with three layers

FIG. 2 shows a composite element with a thin film according to FIG. 1

FIG. 3 shows a thin film comprising a layer as a gas-separating membrane

FIG. 4 shows a porous substrate with a thin film

FIG. 5 shows an impermeable substrate with a continuous hole or channel with a thin film

FIG. 6 shows an impermeable membrane with various forms of hole (plan view)

FIG. 7 shows a miniaturized fuel cell with a composite element

FIG. 8 shows a variant of FIG. 7

FIG. 9 shows a further fuel cell (view from below)

FIG. 10 shows a single-chamber fuel cell with electrodes of a thin-film membrane next to one another

FIG. 11 shows a single-chamber fuel cell with a porous solid electrolyte of the thin-film membrane

FIG. 12 shows a fuel cell according to FIG. 7 with a protective layer on the substrate

FIG. 13 shows a fuel cell according to FIG. 7 with a heating element

FIG. 14 shows a thin film with a gradient

FIG. 15 shows a gas sensor with a thin-film membrane, and

FIG. 16 shows a process sequence for a structured glass substrate

FIG. 17 shows a variant of FIG. 1 with a thin film of five layers

FIG. 18 shows a composite element with a thin film according to FIG. 17.

### WAYS OF CARRYING OUT THE INVENTION

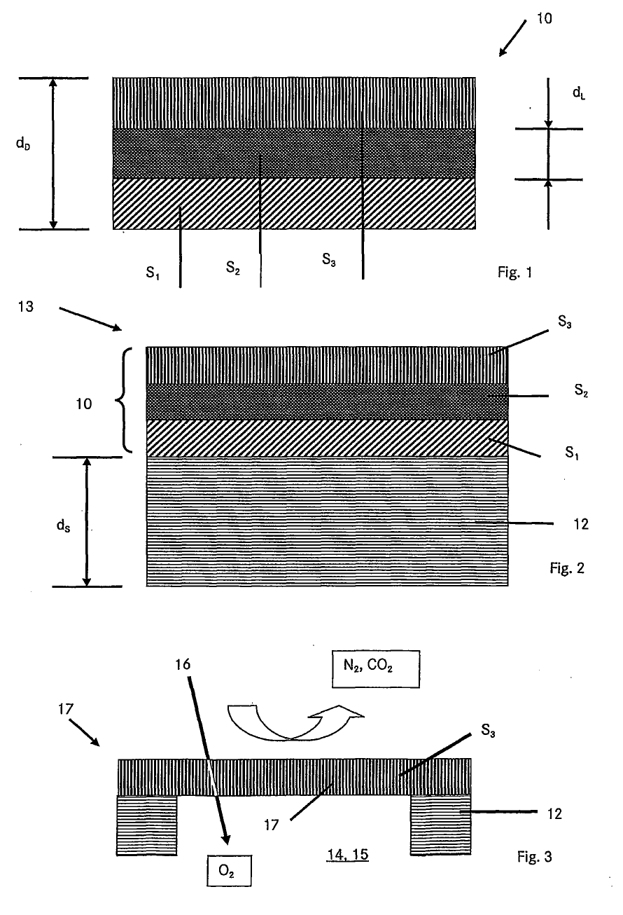

FIG. 1 shows a thin film 10 with a laminate structure comprising three layers, a first layer S₁, a second layer S₂ and a third layer S₃. In the present case, the first layer S₁ is a cermet layer with a proportion of metal of 40% and a proportion of ceramic of 60%; it has the specification Ni—Ce_{0.8}Gd_{0.2}O_{1.9}. The second layer S₂, conducting for reduced oxygen ions O²⁻, has the specification Ce_{0.8}Gd_{0.2}O_{1.9}. The third layer S₃ has in the present case the specification La_{0.6}Sr_{0.4}CO_{0.2}Fe_{0.8}O₃. The thickness of a layer S₁, S₂, S₃ is denoted by d_{L}.

FIG. 2 shows a thin film 10 according to FIG. 1, which comprises a film composite in laminate form comprising the thin film 10 according to FIG. 1, which has been applied to a glass substrate 12 and forms a composite element 13. This substrate 12 imparts the necessary mechanical strength to the thin film 10. According to a preferred variant, the layers S₁, S₂ and S₃ are deposited in series by a method that is known per se, it also being possible for the area extent of the individual layers to differ. A thin film 10 applied to a substrate 12 is also referred to as a membrane or a thin-film membrane. For reasons of clarity, the thickness of the glass substrate d_{S} is shown here and elsewhere as smaller than it should be; it is a multiple of the layer thickness d_{D} of the thin film 10.

Represented in FIG. 3 is a gas-separating membrane 10, which merely comprises a selectively gas-permeable solid electrolyte layer S₃. A hole 14 or channel 15 passing completely through the glass substrate 12 exposes the underside of the thin-film membrane 10 and forms a window. The gas inflow 16, indicated by a straight arrow, is divided at the thin-film membrane 10. The oxygen can pass through the ion-conducting layer S₃ and is separated from the deflected main flow of nitrogen N₂ and carbon dioxide CO₂. The thin film 10 comprising a layer S₂ is therefore also referred to as gas-separating membrane 17.

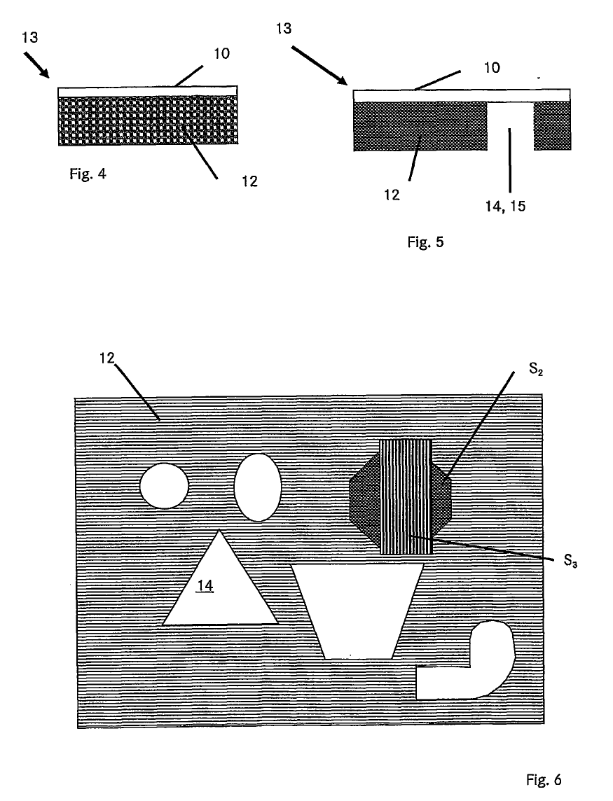

FIGS. 4 to 6 show special embodiments of glass substrates 12 of a flat form. FIG. 4 shows a porous glass substrate 12. A fraction of the gas inflow passing through a thin-film membrane 10 can flow away through the porous glass substrate 12, without holes 14 or channels 15 having to be provided.

A fraction of a gas inflow impinging on a gas-impermeable glass substrate 12 according to FIG. 5 after passing through the thin film 10 must be able to flow away, as represented in FIG. 3, for which reason at least one hole 14 passing through the glass substrate 12, or a corresponding channel 15, must be provided.

FIG. 6 shows a selection of possible embodiments of holes 14 passing through the glass substrate 12, circular, oval, polygonal or any desired form. These holes 14 are always covered by a thin film 10 that is not shown. In the case of a multilayer thin-film membrane, the holes must be covered by at least one layer; the other layers may also cover the hole only partially, as indicated in the case of the octagonal hole 14. The layer S₂, a solid electrolyte, covers the octagonal hole 14 completely; the layer S₃, for example a cathodic layer, covers it only partially.

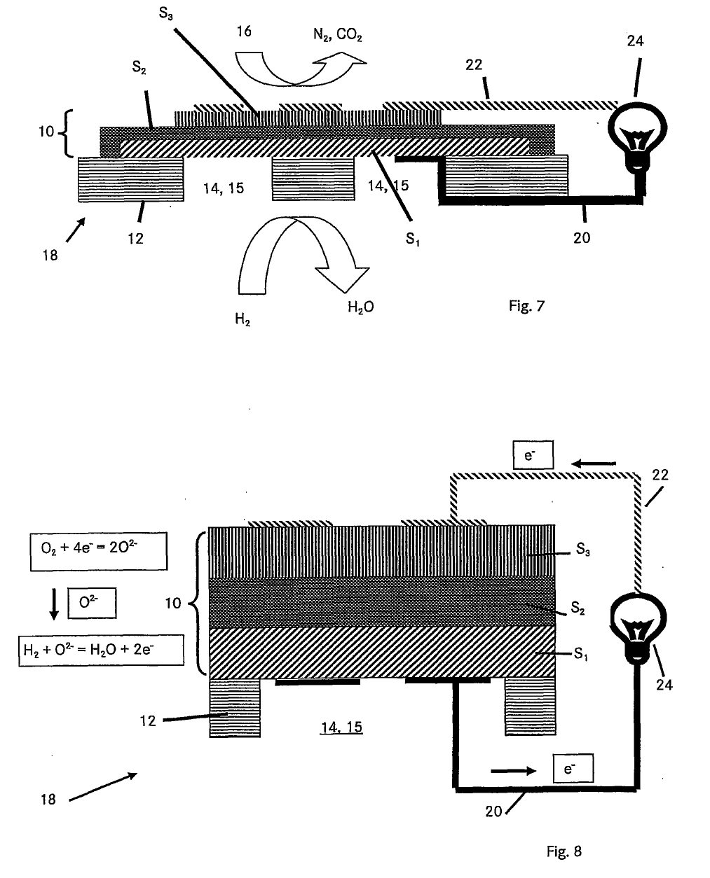

FIGS. 7 and 8 show an important area of use of the thin film 10 or composite element 13 according to the invention, a miniaturized fuel cell 18, the main functional elements of which in two variants of its embodiment are represented. FIG. 7 additionally shows the gas flows, to be specific the gas inflow 16, flowing around the cathodic third layer S₃, and the fuel flow H₂ and/or a hydrocarbon, flowing around the anodic first layer S₁. The atmosphere is oxidizing or reducing, according to the electrode. FIG. 8 also shows the electrochemical reaction sequence.

The thin-film membrane 10 with the electrochemically active layers of the miniaturized fuel cell 18 essentially comprises

an anodic first layer S₁ of a cermet, resting on a rigid glass substrate plate 12 with holes 14 or channels 15,

a second layer S₂, also laterally covering the anode and formed as a solid electrolyte, and

a cathodic third layer S₃, resting on the solid electrolyte.

The anodic layer S₁ and the cathodic layer S₃ are each connected to a metallic current conductor 20, 22 and lead the direct electric current that is generated via a load 24. The electrodes S₁, S₃ may contain catalytically active metal particles.

The electrode layers S₁ and S₃ are formed such that they are gas-permeable; the electrode layer S₂ is gas-impermeable, but permeable to oxygen ions, which is indicated in FIG. 8. When there is an inflow of gas 16, in the present case air, the nitrogen N₂ and the carbon dioxide CO₂ are deflected—as already represented in FIG. 3—, the oxygen ions O²⁻ pass through the solid electrolyte layer S₂ to the anodic first layer S₁ and react at the interface while oxidizing with the hydrogen supplied as fuel to form water. This is carried away as exhaust gas.

As shown in FIG. 8, the electrons e⁻ released during the oxidation of the oxygen ions O²⁻ are led via a load 24 to the cathodic layer S₃, where the reaction it started up again and oxygen is reduced.

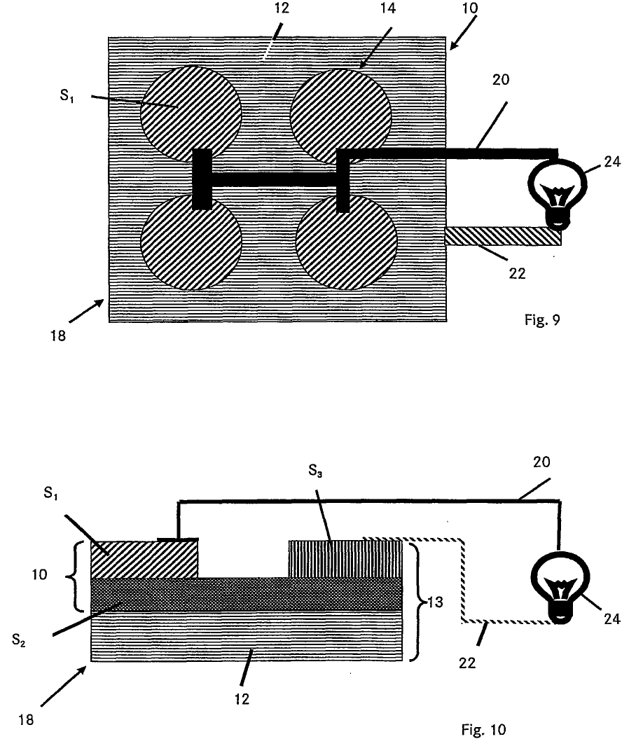

FIG. 9 is a basic diagram of the functional part of a fuel cell SOFC 18, represented from below. The anodic first layer S₁ of a thin-film membrane 10 applied to the substrate 12 can be seen through four holes 14 in a glass substrate 12. A metallic anodic current conductor 20 is connected to this layer S₁ and is connected in an electrically conducting manner via a load 24 and a metallic cathodic current conductor 22 to the cathodic layer of the thin-film membrane 10, which cannot be seen.

Represented in FIG. 10 is the functional principle of a miniaturized single-chamber fuel cell 18, in which the anodic first layer S₁ and the cathodic third layer S₃ are arranged on the same side of the second layer S₂, a solid electrolyte. The thin film 10 is in turn applied to a substrate 12 to form a composite element, and forms a composite element 13. The electric current that is generated by the miniaturized fuel cell SOFC 18 during operation is passed via the metallic current conductors 20, 22 to a load 44.

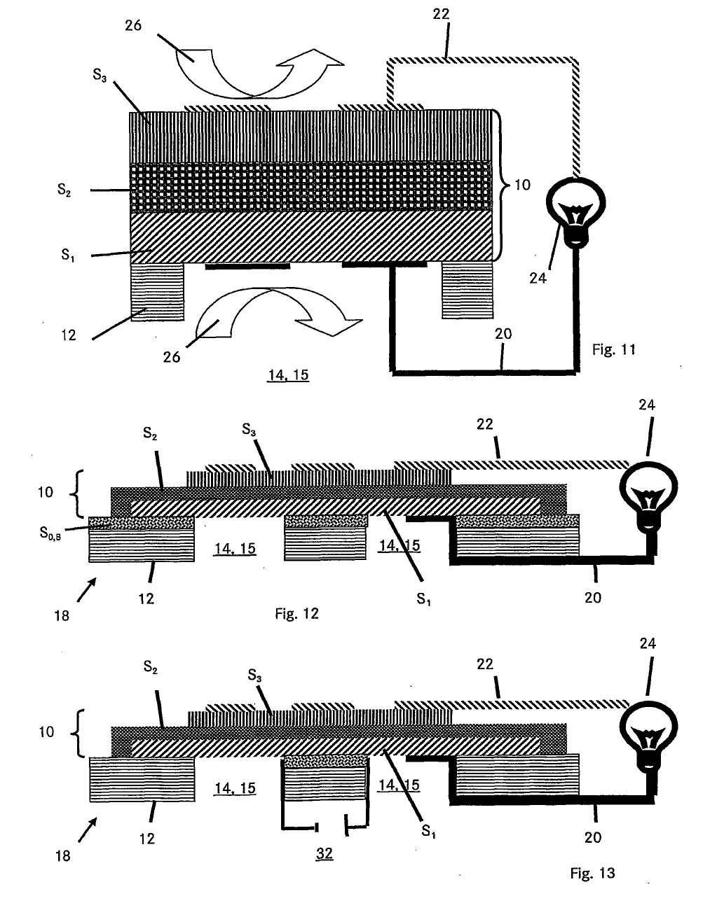

FIG. 11 shows a further miniaturized fuel cell SOFC 18 with a second layer S₂, formed as a porous solid electrolyte. Together with the anodic first layer S₁ and the cathodic layer S₃, this layer forms the thin-film membrane 10, which is supported by a substrate 12 with a hole 14 or channel 15. As usual in a single-chamber SOFC, both the anodic layer S₁ and the cathodic layer S₃ are surrounded by the flow of a mixture of air, fuel and exhaust gas, which is indicated by arrows 26. A hydrocarbon that is introduced along with or in place of H₂ may be liquid or gaseous.

A miniaturized SOFC 18 that is represented in FIG. 12 corresponds essentially to that of FIG. 7. The only significant difference is that a protective layer S_{0,B} is arranged between the anodic layer S₁ and the part of the layer S₂ formed as a solid electrolyte that encloses this anode, on the one hand, and the substrate 12, on the other hand. This protective layer consists in the present case of silicon nitride Si₃N₄.

A further variant according to FIG. 7 is represented in FIG. 13. A heating element 30, which is fed by a direct current source 32, is arranged between the central web 34 of the substrate 12, which separates the two channels 15 for fluid distribution, and the anodic first layer S₁. The heating element 30 may extend over further regions.

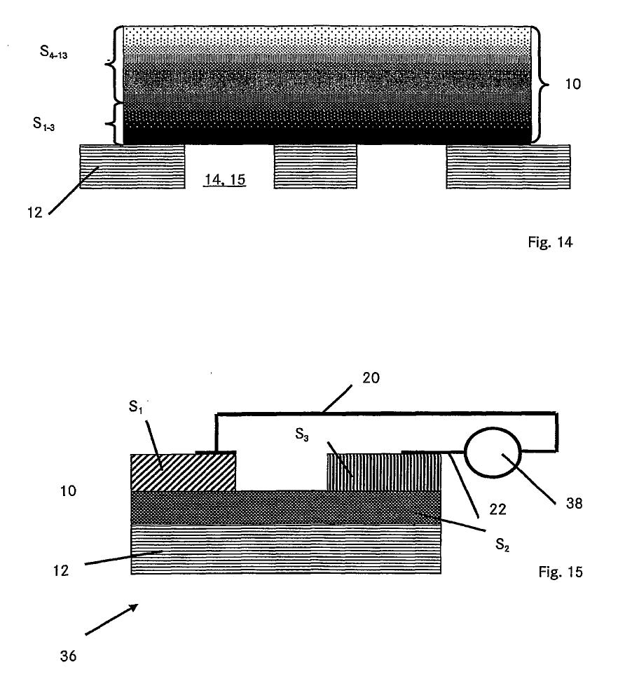

In FIG. 14, a thin film 10 is formed with a total of 13 layers, not only the layers referred to in the previous figures, S₁, S₂ and S₃, but also the layers S₄ to S₁₃. The porosity is constant within the individual layers S₁ to S₁₃, but the individual layers exhibit a porosity that decreases in stages. As a result, a gradient is formed. Parameters other than the porosity may also form a gradient, for example the chemical composition and/or the morphology.

FIG. 15 shows the structural principle of a sensor 36 with a thin film 10 on a substrate 12. The second layer S₂, forming the solid electrolyte, is connected over its full surface area to the impermeable glass substrate 12. On the other side of the second layer S₂, two electrodes are arranged separately from each other, a high-grade metal electrode forming the first layer S₁, in the present case of platinum, and a metal oxide electrode forming the third layer S₃, in the present case of La_{0.6}Sr_{0.4}CrO₃.

The solid electrolyte that is permeable to oxygen ions, layer S₂, consists in the present case of ZrO₂ doped with 8% Y₂O₃. The resistance measured over current conductors 20, 22 is fed to a measuring instrument 38 with a display area.

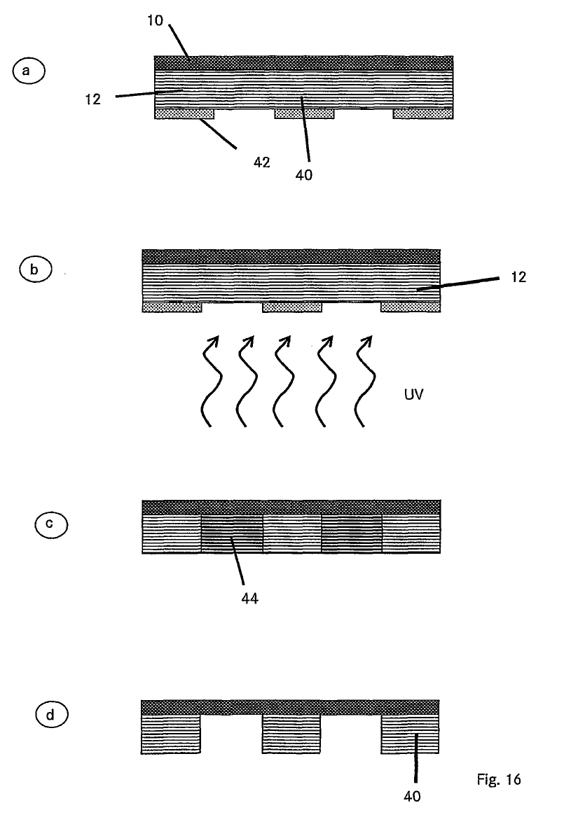

In FIG. 16, the principle of the process sequence for the production of a structured glass substrate 12 with an applied thin-film membrane 10 is represented. The parts 40 of the glass substrate 12 that are not to be irradiated with or exposed to UV are covered with a photoresist 42, as represented in method step a.

In the next method step b, the substrate 12 is exposed to UV and then, in a further method step c, after removal of the photoresist 42, is heat-treated in an oven. The parts 44 of the glass substrate 12 that are exposed to UV rays are thereby partially ceramicized.

The next method step comprises etching out the partially ceramicized parts 44 of the glass substrate 12 as far as the protective layer S_{0,B} (FIG. 12), or if the latter is absent, as far as the thin film 10.

In a final method step d, the parts 40 of the glass substrate that are not exposed to UV rays are put into an oven along with the thin-film membrane 10 and completely ceramicized.

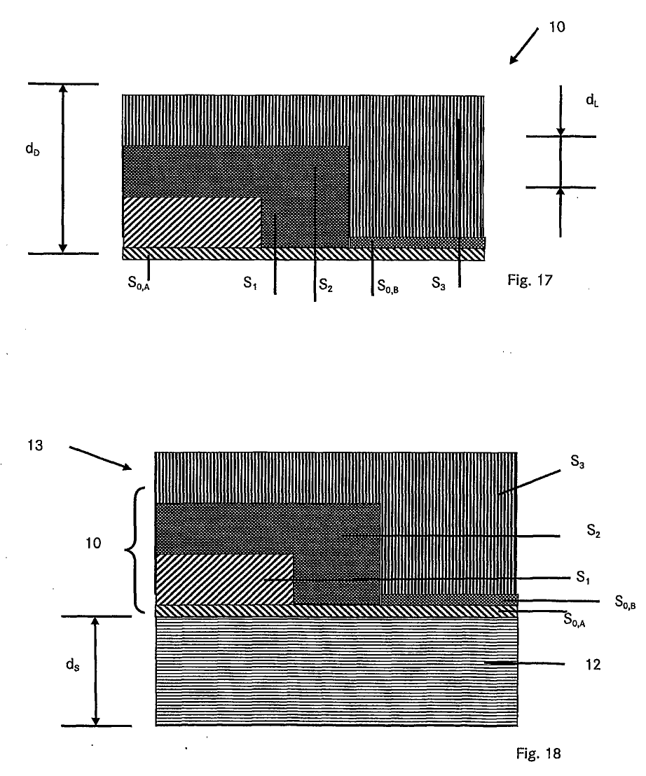

FIG. 17 shows a thin film 10 with a laminate structure of four layers, a first layer S_{0,A}, a second layer S_{0,B}, a third layer S₁, a fourth layer S₂ and a fifth layer S₃. In the present case, the first layer S_{0,A} is a metal layer of Pt, and the second layer S_{0,B}, an insulating layer, consists of SiNₓ, SiCₓ or SiOₓ. The third layer S₁ is a cermet layer with a proportion of metal of 40′ and a proportion of ceramic of 60%; it has the specification Ni—Ce_{0.8}Gd_{0.2}O_{1.9} and the fourth layer S₂, conducting for oxygen ions O²⁻, has the specification Ce_{0.8}Gd_{0.2}O_{1.9}. The fifth layer S₃ has in the present case the specification La_{0.6}Sr_{0.4}CO_{0.2}Fe_{0.8}O₃.

FIG. 18 shows a thin film 10 according to FIG. 17, which comprises a film composite in laminate form, has been applied to a substrate 12 and forms a composite element 13 which serves as a functional element. This substrate 12 imparts the necessary mechanical strength to the thin film 10. According to a preferred variant, the layers S_{0,A}, S_{0,B}, S₁, S₂ and S₃ are deposited in series by a method that is known per se, it also being possible for the area extent of the individual layers to differ. A thin film 10 applied to a substrate 12 is also referred to as a membrane or a thin-film membrane. For reasons of clarity, the thickness of the substrate ds is shown here and elsewhere as smaller than it should be; it is a multiple of the layer thickness d_{D} of the thin film 10.

1. A composite element comprising at least one thin film that consists of at least two different layers of an oxide-ceramic material, an oxide-ceramic and metallic material or a metallic material to form a solid fuel cell (SOFC) and comprising an essentially flat substrate that supports the thin film
wherein
the substrate consists of a ceramicizable glass, a glass ceramic, a mixed form or an intermediate state of the two.

2. The composite element as claimed in claim 1, wherein the substrate consists of a structurable glass which can be etched.

3. The composite element as claimed in claim 1, wherein the substrate and the thin film have a coefficient of thermal expansion that is approximately the same, which preferably lies in the range of (5-20)·10⁻⁶K⁻¹.

4. The composite element as claimed in claim 3, wherein the coefficient of thermal expansion of the thin film lies in the range of (8-15)·10⁻⁶K⁻¹, that of the substrate in the range of (8-10)·10⁻⁶K⁻¹.

5. The composite element as claimed in claim 1, wherein the thickness (d_{S}) of the substrate corresponds to approximately five times, preferably approximately ten times, the total layer thickness (d_{D}) of the thin film.

6. The composite element as claimed in claim 1, wherein the thin-film membrane stretches over porous zones and/or at least one continuous hole or a continuous channel of the substrate.

7. The composite element as claimed in claim 6, wherein the holes or channels in the substrate are at least 100 μm² in size and of any desired geometrical form.

8. The composite element as claimed in claim 1, wherein the substrate is formed as a flexible sheet or as a rigid plate.

9. The composite element as claimed in claim 1, wherein a preferably channel- or groove-shaped fluid distributor is arranged in the free surface of the substrate.

10. The composite element as claimed in claim 1, wherein a protective layer, which preferably consists of at least one of the substances Co, Fe, Cr, Ti, Cu, Au, Ag, Ni, Pt, Ta, Si, Pd, Ru or Rh and is in particular entirely or partially covered by a further layer of SiCₓ, SiNₓ and SiOₓ, is provided as an etching resist or bonding layer in addition to the at least two different layers as a lowermost layer of the thin film.

11. The composite element as claimed in claim 1, wherein a heating element is arranged at least in part of the composite region between the thin film and the glass substrate.

12. The composite element as claimed in claim 1, wherein the thin film has an average grain size of at most approximately 500 nm in all the layers and an essentially stable average grain size is retained in at least one of these layers after a relaxation time, even in an elevated temperature range.

13. The composite element as claimed in claim 1, wherein at least one layer of the thin film is ionically or ionically and electronically conducting, in particular for O²⁻ ions.

14. The composite element as claimed in claim 1, wherein electrically conducting layers of the thin film have a material- and temperature-dependent conductivity of from 0.02 to 10⁵ S/m.

15. The composite element as claimed in claim 1, wherein the chemical composition, the morphology and/or the porosity of neighboring layers of the thin film, which are homogeneous within an individual layer, increase or decrease continuously to form a corresponding gradient.

16. The composite element as claimed in claim 1, wherein at least one layer of the thin film has a porosity of >0 to 70% by volume.

17. The composite element as claimed in claim 1, wherein the thin film comprises an anodic layer, a solid electrolyte layer and a cathodic layer, all the layers preferably being electrically conducting.

18. The composite element as claimed in claim 1, wherein at least one layer of the thin film consists of at least one ceramic or of at least one ceramic and at least one metal.

19. A method for producing a substrate for a composite element as claimed in claim 1, wherein regions are selectively dissolved out of the structurable glass substrate.

20. The method as claimed in claim 19, wherein the parts of the surface that are to be removed are exposed to UV, heated up for at least partial, selective transformation into glass ceramic, these exposed parts are specifically removed and the parts that are not exposed are subsequently preferably ceramicized.

21. The use of a composite element as claimed in claim 1, wherein in a miniaturized electrochemical device, in particular in a solid oxide fuel cell SOFC, a sensor or as a gas-separating membrane.
